(19) United States
(12) Patent Application Publication
(10) Pub. No.: US 2022/0144972 A1
(43) Pub. Date: May 12, 2022

(54) SURFACE-NANOCRYSTALLIZED CELLULOSE-CONTAINING BIOMASS MATERIAL, PREPARATION METHOD AND USE THEREOF

(71) Applicant: University of Science and Technology of China, Hefei (CN)

(72) Inventors: Shuhong Yu, Hefei (CN); Qingfang Guan, Hefei (CN); Zimeng Han, Hefei, Anhui (CN); Huaibin Yang, Hefei (CN); Zhangchi Ling, Hefei (CN)

(73) Assignee: University of Science and Technology of China, Hefei (CN)

(21) Appl. No.: 17/436,008

(22) PCT Filed: Dec. 13, 2019
(86) PCT No.: PCT/CN2019/125209

§ 371 Date: Sep. 2, 2021

(30) Foreign Application Priority Data
May 14, 2019 (CN) 201910401182.6

(51) Int. Cl. C08B 15/04; C08B 1/00

(52) U.S. Cl. CPC C08B 15/04; C08B 1/00

(57) ABSTRACT

The present disclosure provides a surface-nanocrystallized cellulose-containing biomass material, a preparation method and use thereof. The cellulose-containing biomass material is one or more derived from biomass materials containing cellulose components from natural plants or animals. Nanoscale celluloses are present on a surface of the surface-nanocrystallized cellulose-containing biomass material, and a portion of hydroxyl groups in the cellulose structure has been converted to carboxyl groups, such that the surface-nanocrystallized cellulose-containing biomass material has high specific surface area, high surface activity, and high crystallinity. Thus, the present application provides an excellent raw material for the further processing of biomass materials.

### TECHNICAL FIELD

The present disclosure relates to the technical field of nanotechnology, and particularly to a surface-nanocrystallized cellulose-containing biomass material, a preparation method and use thereof.

### BACKGROUND

Adjustment and control of micro/nano-structure has become an important means in the field of material research and development. The properties of a series of conventional materials have been improved through the adjustment and control of micro/nano-structure. For example, the toughness of ceramic materials is improved by adjusting the structure of the ceramic materials to simulate biological lamella. A substantial improvement in properties such as fatigue resistance has been achieved by adjusting the twin crystal structures of metal materials.

As the most abundant renewable resource on the earth, biomass has a wide range of applications. China is a great agricultural country, and produces a trillion kilograms of biomass in total every year, which is consisted of 0.7 trillion kilograms of agricultural straws and 0.3 trillion kilograms of forest wood wastes. The methods for treating these wastes comprise discarding and burning. The former results in environmental pollution and wastes a large amount of land to stack the wastes, and the latter results in more severe case where the burning of such a large amount of wastes will cause a significant effect on the climate of the earth. In the technologies for processing biomass, a main approach is to a further processing step starting from a biomass material. However, there is still a problem that a biomass material obtained by direct pulverization has disadvantages such as poor reactivity and low specific surface area, limiting the processing and application of the biomass material.

Therefore, the development of a simple and efficient method to improve the surface reactivity and surface area of a biomass material is of a significance on the processing of the biomass material.

### SUMMARY

An object of the present disclosure is to provide a cellulose-containing biomass material having high specific surface area, high surface activity and high crystallinity, so as to provide an excellent raw material for further processing of a biomass material. Meanwhile, another object of the present disclosure is to provide a method for surface-nanocrystallizing a cellulose-containing biomass material.

In this regard, the present disclosure provides technical solutions as follows.

<1>. A surface-nanocrystallized cellulose-containing biomass material, wherein the cellulose-containing biomass material is derived from one or more of biomass materials containing cellulose components from natural plants or animals, wherein a surface of the surface-nanocrystallized cellulose-containing biomass material has an exposed region, and celluloses in the exposed region are nanoscale celluloses, and wherein a portion of hydroxyl groups in the nanoscale celluloses has been converted to carboxyl groups, such that the surface-nanocrystallized cellulose-containing biomass material has at least one of the following properties:

i) that the surface-nanocrystallized cellulose-containing biomass material has a specific surface area of at least 1.5 m²/g, preferably at least 10 m²/g, and more preferably at least 30 m²/g;

ii) that celluloses (i.e. surface-exposed celluloses) having the exposed region in the surface-nanocrystallized cellulose-containing biomass material after nanocrystallization have a diameter of at least 1 μm or less, preferably 500 nm or less, and more preferably 100 nm or less;

iii) that in the surface-nanocrystallized cellulose-containing biomass material, the celluloses have a crystallinity of at least 65%, preferably at least 70%, and more preferably at least 75%;

iv) that in the surface-nanocrystallized cellulose-containing biomass material, a molar ratio of carboxyl groups relative to a total amount of hydroxyl groups and carboxyl groups is at least 5%, preferably at least 10%, and more preferably at least 30%;

v) that the surface-nanocrystallized cellulose-containing biomass material has a viscosity of greater than 40 mPa·s, preferably greater than 60 mPa·s, and more preferably greater than 80 mPa·s, as measured at about 25° C. by a rotational viscometer method with a mass fraction of 6% of the surface-nanocrystallized cellulose-containing biomass material in water; and

vi) that an aqueous solution of the surface-nanocrystallized cellulose-containing biomass material has a settling time of at least 200 minutes or longer, preferably at least 500 minutes or longer, and more preferably at least 800 minutes or longer.

<2>. The surface-nanocrystallized cellulose-containing biomass material according to <1>, wherein the surface-exposed celluloses after surface nanocrystallization have a fiber length in a range from 0.1 to 5 μm.

<3>. The surface-nanocrystallized cellulose-containing biomass material according to <1>, wherein the cellulose-containing biomass material has a cellulose content of 10% to 90%, preferably 20% to 70%, and more preferably 30% to 50%.

<4>. The surface-nanocrystallized cellulose-containing biomass material according to <1>, wherein the natural plants or animals are at least one selected from the group consisting of wood, saw dust, leaf, straw, hay, hemp, bamboo, bagasse or rice hull of natural plants, and seashell of natural animals.

<5>. The surface-nanocrystallized cellulose-containing biomass material according to <1>, wherein the cellulose-containing biomass material is in a form of particles.

<6>. A method for preparing a surface-nanocrystallized cellulose-containing biomass material, comprising steps of:

A) subjecting a cellulose-containing biomass material to a surface etching treatment in an etching solution, the cellulose-containing biomass material being one or more selected from biomass materials containing cellulose components from natural plants or animals;

B) subjecting the cellulose-containing biomass material after the etching treatment to a surface oxidation treatment;

C) subjecting the cellulose-containing biomass material after the surface oxidation to a mechanical treatment; and

D) making the cellulose-containing biomass material after the mechanical treatment form a dispersion solution or dry powder for storage.

<7>. The method according to <6>, wherein the etching solution comprises at least one selected from the group consisting of aqueous sodium hydroxide solution, aqueous potassium hydroxide solution, aqueous sodium sulfite solution, aqueous sulfur dioxide solution, aqueous sulphurous acid solution, and a solvent capable of dissolving biomacromolecules.

<8>. The method according to <6>, wherein in step A), the cellulose-containing biomass material is in a form of particles, and has a particle size of 0.1 μm to 5 mm.

<9>. The method according to <6>, wherein the surface oxidation treatment comprises oxidizing surface-exposed celluloses of the cellulose-containing biomass material under a catalytic action of 2,2,6,6-tetramethylpiperidine-N-oxide.

<10>. The method according to <6>, wherein in step A), the etching solution has a mass concentration of 0.1% to 50%.

<11>. The method according to <6>, wherein in step B), the surface oxidation treatment is performed by oxidizing surface celluloses of the cellulose-containing biomass material with an oxidizing agent under a catalytic action of 2,2,6,6-tetramethylpiperidine-N-oxide, and wherein the oxidizing agent comprises at least one water-soluble oxidizing agent selected from the group consisting of sodium chlorite, sodium hypochlorite, sodium bromite, and sodium hypobromite.

<12>. The method according to <6>, wherein the mechanical treatment comprises one or more of stirring, grinding, high pressure homogenization and high pressure injection.

<13>. The method according to <6>, wherein in step A), the etching is performed at a temperature of 10-200° C. for 1-72 h.

<14>. The method according to <6>, wherein in step B), the oxidation treatment reaction is performed at a temperature of 10-150° C. for 6-240 h.

<15>. Use of the surface-nanocrystallized cellulose-containing biomass material according to any one of <1>-<5> and the surface-nanocrystallized cellulose-containing biomass material obtained by the method according to any one of <6>-<14> in preparing a thin film, a plate, an water-based coating, a composite functional nanomaterial, a biomass sponge, a high performance carbon material or an aerogel material.

<16>. The use according to <15>, wherein a slurry of the surface-nanocrystallized cellulose-containing biomass material is directly dried to form a thin film or plate which has a desire strength and where the surface-nanocrystallized cellulose-containing biomass materials are bonded together.

<17>. The use according to <15>, wherein a slurry of the surface-nanocrystallized cellulose-containing biomass material is freeze dried to form an aerogel material with a desire strength and elasticity.

<18>. The use according to <15>, wherein the use comprises use in an indoor decorative material.

### BRIEF DESCRIPTION OF DRAWINGS

FIG. 1 shows a digital photograph of a dispersion solution of the surface-nanocrystallized biomass material prepared in Example 1 of the present disclosure.

FIG. 2 shows a comparison between scanning electron microscope photographs of the surface of wood chips which are not treated according to the present disclosure (FIG. 2A) and cellulose-containing biomass particles (wood chip particles) which are treated by the surface-nanocrystallization method of the present disclosure (FIG. 2B). As can be seen from FIG. 2A, the surface of the untreated wood chips is relatively smooth, and does not have a large amount of fiber structures; the surface of the wood chip particles treated by the present method has a large amount of nanoscale fibers, with one end of each fiber protruding and the other end inserted into the particles.

FIG. 3 shows results from carbon nuclear magnetic resonance (C-NMR) spectroscopy (Bruker Avance III 400 WB) for the untreated biomass particles, the alkali-treated biomass particles, and the surface-nanocrystallized biomass particles, which results indicate that an obvious carboxyl peak appears after cellulose-containing biomass particles are surface-nanocrystallized, demonstrating that carboxyl groups are produced during the oxidation.

FIG. 4 shows the change in the specific surface areas of the untreated cellulose-containing biomass particles (wood chips), the alkali-treated cellulose-containing biomass particles (wood chips), and the surface-nanocrystallized cellulose-containing biomass particles (wood chips), and indicates that the specific surface areas are increased after the surface nanocrystallization. The specific surface areas are determined by using iQ₂ (Quantachrome Instruments, USA) according to a multi-point BET method.

FIG. 5 shows the change in the viscosity of the surface-nanocrystallized cellulose-containing biomass particles (wood chips). This figure shows that the surface-nanocrystallized cellulose-containing biomass material has a viscosity significantly higher than those of the untreated cellulose-containing biomass particles and the alkali-treated cellulose-containing biomass particles. The viscosity is determined by using a rotational viscometer NDJ-1 (Shanghai Xingliang Optical Instruments Co., Ltd.). When the cylinder is rotating, the polymer liquid in the slit flows under an action of shearing.

FIG. 6 shows the change in the crystallinity of the surface-nanocrystallized cellulose-containing biomass particles (wood chips), wherein: A) shows the X-ray diffraction curves of the untreated cellulose-containing biomass particles, the alkali-treated cellulose-containing biomass particles, and the surface-nanocrystallized cellulose-containing biomass particles, and B) shows the relative crystallinity histogram calculated from the X-ray diffraction curves. After the surface nanocrystallization, the relative crystallinity is increased. PANalytical X′pert PRO MRD X ray diffractometer is used. The sample is uniformly placed on a silicon sheet, and put into the X ray diffractometer together with the silicon sheet to obtain the data.

FIG. 7 shows a digital photograph of a coating material applied to a wood surface according to the Application Example 1 of the present disclosure. In a scratch test with a load of 1.45 kilograms, only minor scratches appear, without penetration.

FIG. 8 shows a digital photograph according to Example 4 of the present disclosure, and is used for comparing with FIG. 7. A slurry of the same kind of wood chip sample which has not been treated by the method of the present disclosure is applied to the same substrate and dried. After that, no coating layer is formed, and the sample is still in a powder form. The powders fall off after tilting the substrate.

FIG. 9 shows a digital photograph of an aqueous slurry formed from the surface-nanocrystallized cellulose-containing biomass material according to Example 1 of the present disclosure after the aqueous slurry has been applied to a substrate of cement board for one month. As can be seen, its apparent properties remain stable, and it does not fall off, peel off or wrinkle due to normal changes in the temperature and humidity of the ambient environment.

FIG. 10 shows a scratch test for an aqueous slurry which is formed from the surface-nanocrystallized cellulose-containing biomass material according to Example 1 of the present disclosure, and applied to a substrate of cement board. No scratch appears until the load reaches 1.50 kg, indicating a good scratch resistance.

FIG. 11 shows a digital photograph of a comparative slurry coating material after it has been applied to a substrate of cement board for one month. As can be seen, its appearance is obviously granular; the material as a whole is relatively loose, and cannot form a tough coating film.

FIG. 12 shows a scratch test for the comparative slurry coating material applied to a substrate of cement board. Scratches appear at a load of 0 kg, indicating a poor scratch resistance.

### DETAILED DESCRIPTION

A first aspect of the present disclosure provides a surface-nanocrystallized cellulose-containing biomass material having high specific surface area, high surface activity and high crystallinity, so as to provide an excellent raw material for further processing of a biomass material.

The term “cellulose-containing biomass material” refers to one or more of biomass materials containing cellulose components derived from natural plants or animals, including but not limited to at least one selected from a group consisting of wood, saw dust, leaf, straw, hay, hemp, bamboo, bagasse or rice hull of natural plants, and seashell of natural animals. The cellulose-containing biomass material may have various shapes, but preferably is in a form of particles, in particular particles having a particle diameter of 0.1 to 500 μm, from a viewpoint of ease to handle the reaction. The cellulose-containing biomass material may have a cellulose content of 10% to 90%, preferably 20% to 70%, and more preferably 30% to 50%.

The phrase “surface nanocrystallized” refers to that the cellulose-containing biomass material has nanocrystallized microstructures on its surface, and specifically refers to that the cellulose-containing biomass material has nanoscale celluloses on its surface, and a portion of hydroxyl groups in the cellulose structure has been converted to carboxyl groups. The term “nanoscale cellulose” refers to a cellulose with a nanoscale diameter. For example, the product obtained after the surface nanocrystallization treatment in Example 1 has fibers with a diameter between 10 and 100 nm on its surface. Preferably, a molar ratio of the carboxyl groups relative to the hydroxyl groups is at least 0.5%, more preferably at least 3%, and still more preferably at least 30%. Surface-exposed celluloses in the surface-nanocrystallized cellulose-containing biomass material after nanocrystallization have at least a diameter of 1 μm or less, preferably at least 500 nm or less, and more preferably at least 100 nm or less, for example, in a range from 7 to 1000 nm or from 100 to 800 nm. The surface-exposed celluloses after nanocrystallization have a fiber length in a range from 0.1 to 5 μm. For example, the fiber length may be in a range from 0.5 to 4 μm or from 2 to 3 μm. In the surface-nanocrystallized cellulose-containing biomass material of the present disclosure, the nanoscale fibers are dispersed such that one end of each fiber is embedded into the interior of the biomass material, and the other end protrudes from the surface of the biomass material, and well dispersed.

The appearance and processing properties of the surface-nanocrystallized cellulose-containing biomass material of the present disclosure are significantly different from those of the untreated and surface-etched cellulose-containing biomass materials with respect to many aspects. For example, A) in terms of microscopic morphology, the surface of the original biomass material is relatively smooth, microscale celluloses are exposed on the surface of the surface-etched particles, and a large amount of nanoscale celluloses are produced on the surface of the surface-nanocrystallized material. B) After the surface nanocrystallization, the specific surface area is increased. For example, the surface-nanocrystallized material has a specific surface area 3 times greater than that of the untreated sample. C) Because a large amount of nanoscale celluloses present on the surface form long-range hydrogen bond interaction and are entangled with each other, the viscosity of the surface-nanocrystallized material is significantly increased. For example, the slurry of the surface-nanocrystallized biomass material at the same concentration has a viscosity 2.5 times greater than that of the slurry of the untreated material and the slurry of the surface-etched material. D) Compared to the slurry of the untreated material and the slurry of the surface-etched material, the settling rate of the slurry of the surface-nanocrystallized biomass material at the same concentration is greatly reduced. For example, the period for the former to sufficiently settle is less than 10 minutes, while the latter is not completely settled after 600 minutes. E) The present inventors have found that the surface-nanocrystallized biomass material may directly form a thin film or a plate having a certain strength and being bonded together through direct dry of the slurry thereof because the surface-nanocrystallized biomass material has increased specific surface area and increased surface reactivity, while only powders can be obtained by drying the slurry of the untreated material and the slurry of the surface-etched material. F) The present inventors have also found that an aerogel material with certain strength and elasticity can be obtained by freeze drying the slurry of the surface-nanocrystallized biomass material due to increased specific surface area and increased surface reactivity, while only powders can be obtained by freeze drying the slurry of the untreated material and the slurry of the surface-etched material.

Therefore, a surface of the surface-nanocrystallized cellulose-containing biomass material has an exposed region, and celluloses in the exposed region are nanoscale celluloses, and a portion of hydroxyl groups in the nanoscale celluloses has been converted to carboxyl groups, such that the surface-nanocrystallized cellulose-containing biomass material has at least one, preferably at least 2, more preferably at least 3, more preferably at least 4, more preferably at least 5, and the most preferably all of the following properties:

i) that the surface-nanocrystallized cellulose-containing biomass material has a specific surface area of at least 1.5 m²/g, preferably at least 10 m²/g, and more preferably at least 30 m²/g;

ii) that surface-exposed celluloses of the surface-nanocrystallized cellulose-containing biomass material after being nanocrystallized have at least a diameter of 1 μm or less, preferably at least 500 nm or less, and more preferably at least 100 nm or less;

iii) that in the surface-nanocrystallized cellulose-containing biomass material, the celluloses have a crystallinity of at least 65%, preferably at least 70%, and more preferably at least 75%;

iv) that in the surface-nanocrystallized cellulose-containing biomass material, a molar ratio of carboxyl groups relative to a total amount of hydroxyl groups and carboxyl groups is at least 5%, preferably at least 10%, and more preferably at least 30%;

v) that the surface-nanocrystallized cellulose-containing biomass material has a viscosity of greater than 40 mPas, preferably greater than 60 mPas, and more preferably greater than 80 mPas, in an aqueous solution with a mass fraction of 6%, as measured at about 25° C. by a rotational viscometer method; and

vi) that an aqueous solution of the surface-nanocrystallized cellulose-containing biomass material has a settling time of at least 200 minutes or longer, preferably at least 500 minutes or longer, and more preferably at least 800 minutes or longer.

In the present disclosure, the term “exposed region” refers to a surface region formed by etching the surface of a cellulose-containing biomass material in an alkali treatment. Relative to the surface before the alkali treatment, the exposed region may be greater than 0% to 100%, for example, at least 5%, at least 10%, at least 20%, at least 50%, at least 80%, at least 90%, and preferably at least 100%.

A second aspect of the present disclosure provides a preparation method for surface nanocrystallization of a cellulose-containing biomass material, comprising steps of:

A) subjecting a biomass material to a surface etching treatment in an etching solution, the biomass material being one or more selected from biomass materials containing cellulose components from natural plants or animals;

B) subjecting the biomass material obtained after the etching treatment to a surface oxidation treatment;

C) subjecting the biomass material obtained after the surface oxidation to a mechanical treatment; and

D) making the biomass material obtained after the mechanical treatment to form a dispersion or dry powder for storage.

Preferably, the biomass material includes but not limited to at least one selected from the group consisting of wood, saw dust, leaf, straw, hay, hemp, bamboo, bagasse or rice hull of natural plants, and seashell of natural animals.

In the present disclosure, the etching solution is a solution capable of dissolving lignin and hemicellulose or a solvent capable of dissolving biomacromolecules, and functions to form a region wherein celluloses are exposed on the surface of the cellulose-containing biomass material. Preferably, the etching solution is one or more selected from the group consisting of aqueous sodium hydroxide solution, aqueous potassium hydroxide solution, aqueous sodium hydroxide-sodium sulfite solution, aqueous sodium sulfite solution, aqueous sulphurous acid solution and aqueous sulfur dioxide solution, or is a solvent capable of dissolving biomacromolecules selected from acetone, toluene, ethanol and the like. Preferably, the etching solution has a mass concentration of 0.1% to 50%.

In the method for surface-nanocrystallizing a cellulose-containing biomass material provided in the present disclosure, the biomass material is first subjected to a surface etching treatment in an etching solution and washed, the biomass material obtained after the etching treatment is then subjected to a surface oxidation treatment and then a mechanical treatment, obtaining a biomass material with high specific surface area, high surface activity and high crystallinity, which provides an excellent raw material for further processing of a biomass material. In the present disclosure, non-cellulose components are removed by subjecting the cellulose-containing biomass material to a surface etching treatment in an etching solution, so as to expose celluloses. Then, the celluloses are subjected to an oxidation treatment to convert hydroxyl groups on the surface of the celluloses to carboxyl groups. Further, through the mechanical treatment, the celluloses swell and exfoliate into nanocelluloses. This process greatly increases the surface area of the biomass material, significantly improving the activity of the biomass material and making it easier to further process the biomass material.

Therefore, in the present disclosure, the solution for the surface oxidation treatment refers to an aqueous solution which can selectively oxidize the surface of cellulose nanofibers in the biomass material, but will not destroy the internal structure of the nanofibers. Preferably, the solution for the surface oxidation treatment is one or more selected from the group consisting of a solution of neutral 2,2,6,6-tetramethylpiperidine-N-oxide-sodium chlorite, a solution of 2,2,6,6-tetramethylpiperidine-N-oxide-sodium hypobromite, and a solution of 2,2,6,6-tetramethylpiperidine-N-oxide-sodium hypochlorite, wherein the 2,2,6,6-tetramethylpiperidine-N-oxide serves as a catalyst with a catalytic amount. The solution for the surface oxidation treatment typically has a mass concentration of 0.1% to 10%, preferably 0.15% to 8%, and more preferably 1% to 5%.

In the present disclosure, the mechanical treatment functions to make the celluloses of the cellulose-containing biomass material obtained after being subjected to the surface oxidation swell and exfoliate into nanocelluloses, and may be one or more selected from stirring, grinding, ball milling, and high pressure homogenization.

Preferably, in step A), the mixing time (i.e., the etching time) is 1-120 hours (h), preferably 3-80 h, and more preferably 20-40 h. The mixing temperature (i.e., the etching temperature) is 10-120° C., preferably 30-120° C., and more preferably 50-100° C.

Preferably, in step B), the oxidation is performed for 6-240 h, preferably 15-150 h, and more preferably 20-60 h. The reaction temperature is 10-150° C., preferably 20-100° C., and more preferably 40-90° C.

According to the present disclosure, the raw materials in the method for surface-nanocrystallizing a cellulose-containing biomass material comprise a cellulose-containing biomass material, an etching solution, and an oxidation solution. In the present disclosure, the biomass material is one or more selected from biomass materials containing cellulose components from natural plants or animals. In a particular example, the biomass material is preferably wood chips or straw.

The above surface etching solution is used to etch non-cellulose components on the surface of the cellulose-containing biomass material. As the surface etching solution, a solution having corrosion reactivity with a biomass, such as sodium hydroxide solution, potassium hydroxide solution, sodium sulfite solution, sulfur dioxide solution and sulphurous acid solution, may be selected. In a particular example, the surface etching solution comprises aqueous solutions of sodium hydroxide, potassium hydroxide, sodium sulfite, sulfur dioxide, sulphurous acid or the like, another solutions capable of dissolving lignin and hemicellulose, and a solvent capable of dissolving biomacromolecules, such as acetone, toluene and ethanol. The etching solution has a mass concentration of 0.1% to 50%. In a particular embodiment, the etching solution is selected from a solution of sodium hydroxide with a mass concentration of 10%.

The above surface oxidation treatment method comprises the oxidation process of celluloses catalyzed by 2,2,6,6-tetramethylpiperidine-N-oxide, wherein under the catalysis of 2,2,6,6-tetramethylpiperidine-N-oxide, celluloses on the surface of the particles are oxidized with an oxidizing agent. The oxidizing agent comprises water soluble oxidizing agents such as sodium chlorite, sodium hypochlorite, sodium bromite and sodium hypobromite and has a mass concentration of 0.1% to 10%, and the temperature for the oxidizing process is 10-90° C. In a particular embodiment, the 2,2,6,6-tetramethylpiperidine-N-oxide has a concentration of 0.05-10 mg/mL. In a particular example, sodium hydroxide or sodium sulfite is preferably used in the surface etching solution.

In a particular example, the mechanical treatment comprises conventional treatment means such as stirring, grinding, high pressure homogenization and high pressure injection. In a particular embodiment, the mechanical treatment is preferably grinding or high pressure homogenization.

According to the present disclosure, after the cellulose-containing biomass material as a raw material is prepared, the cellulose-containing biomass material is surface-nanocrystallized. The biomass material is subjected to a surface etching treatment in an etching solution to etch the surface and expose the celluloses. In this process, the etching solution dissolves a portion of the non-cellulose components in the cellulose-containing biomass material to expose the celluloses on the surface. The etching temperature is 10-200° C., and the etching time is 1-72 h. In a particular embodiment, the etching temperature is 80° C., and the etching time is 24 h.

According to the invention above, the biomass material obtained after the above etching treatment is then subjected to a surface oxidation treatment. In this treatment, the mild oxidation process catalyzed by 2,2,6,6-tetramethylpiperidine-N-oxide can selectively oxidize the surface of cellulose nanofibers in the biomass material, but will not destroy the internal structure of the nanofibers. After the oxidation is completed, a portion of hydroxyl groups on the surface of the cellulose nanofibers are converted to carboxyl groups, and the celluloses has improved crystallinity. A large amount of nanocelluloses are produced on the surface of the particles. One end of each nanocellulose produced on the surface protrudes, and the other end is inserted into the particles. The mechanical treatment comprises conventional treatment means such as stirring, grinding, high pressure homogenization and high pressure injection. Preferably, the treatment is performed by mechanically grinding.

The carboxylated surface absorbs water and swells during further stirring or another mechanical treatment, and thus water molecules enter between the nanofiber, such that the cellulose nanofibers, which are originally aggregated into bundles on the surface of the biomass material, are dispersed into nanofibers in which one end of each nanofiber is embedded into the interior of the biomass material, and the other end is well dispersed. After the above etching, oxidation and mechanical treatment of these nanofibers protruding from the surface of the biomass material, a surface-nanocrystallized cellulose-containing biomass material is obtained. In the material, a portion of hydroxyl groups on the surface of the cellulose nanofibers is converted to carboxyl groups, and the crystallinity of the celluloses are improved. A large amount of nanocelluloses are produced on the surface of the particles. One end of each nanocellulose produced on the surface protrudes, and the other end is inserted into the particles. Macroscopically, the specific surface area of the particles is increased, the viscosity of the slurry is increased, and the settling rate of the slurry is reduced. As a result, the biomass material treated by this method has a wide range of application prospects. The oxidation temperature is 10-90° C., and the oxidation time is 12-240 h. In a particular embodiment, the oxidation temperature is 60° C., and the oxidation time is 24 h.

In the present disclosure, the product obtained is finally dispersed in a solvent to prepare a dispersion, or dried to obtain powders. The drying process comprises ambient pressure oven drying, freeze drying or supercritical CO₂ drying.

In sum, in the method for surface-nanocrystallizing a cellulose-containing biomass material provided in the present disclosure, the biomass material is first subjected to a surface etching treatment in an etching solution and a washing process, the biomass material obtained after the etching treatment is then subjected to a surface oxidation treatment and then a mechanical treatment, obtaining a biomass material with high specific surface area and high surface activity, which provides an excellent raw material for further processing of a biomass material. In the present disclosure, non-cellulose components are removed by subjecting the cellulose-containing biomass material to a surface etching treatment in an etching solution, thereby exposing celluloses. Then, the celluloses are subjected to an oxidation treatment to convert hydroxyl groups on the surface of the celluloses to carboxyl groups. Further, the celluloses swell and exfoliate into nanocelluloses, thereby obtaining a surface-nanocrystallized biomass material with high specific surface area and high reactivity. The surface-nanocrystallized biomass material obtained in the present disclosure achieves many properties. A portion of hydroxyl groups on the surface of the cellulose nanofibers is converted to carboxyl groups, and the crystallinity of the celluloses are improved. A large amount of nanocelluloses are produced on the surface of the particles. One end of each nanocellulose produced on the surface protrudes, and the other end is inserted into the particles. Macroscopically, the specific surface area of the particles is increased, the viscosity of the slurry is increased, and the settling rate of the slurry is increased. So, the present application provides an excellent raw material for further processing of a biomass.

As compared to the untreated cellulose-containing biomass material as a raw material, the surface-nanocrystallized cellulose-containing biomass material obtained by the method of the present disclosure has at least one, preferably at least 2, more preferably at least 3, and more preferably all of the following properties:

i) that the surface-nanocrystallized cellulose-containing biomass material has a specific surface area about at least 1.5 times, preferably at least 2 times, and more preferably at least 3 times greater than that of the cellulose-containing biomass material which has not been surface nanocrystallized;

ii) that the slurry of the surface-nanocrystallized cellulose-containing biomass material has a viscosity about at least 1.5 times, preferably at least 2 times, and more preferably at least 2.5 times greater than that of the slurry of the cellulose-containing biomass material which has not been surface-nanocrystallized;

iii) that the slurry of the surface-nanocrystallized cellulose-containing biomass material has a low settling rate, with a settling time of at least 200 minutes or longer, preferably at least 600 minutes or longer, and more preferably at least 700 minutes or longer; and

iv) that in the surface-nanocrystallized cellulose-containing biomass material, the celluloses have a crystallinity increased by at least 10%, preferably at least 20%, and more preferably at least 35% as compared to the cellulose-containing biomass material which has not been surface nanocrystallized.

In the present disclosure, the measurement of the specific surface area is determined by a BET absorption test method.

In the present disclosure, the measurement of the viscosity is obtained at about 25° C. by a rotational viscometer method. Specifically, the probe of the rotational viscometer connected with No. 1 rotor is immersed into a solution with a mass fraction. The rotation speed is set to 60 rpm. The rotation motor is started. The reading is recorded after steadily rotating for 20 s.

In the present disclosure, the settling time is measured as follows: a slurry with a mass fraction of 0.1% is thoroughly stirred with a magnetic stirrer, immediately poured into a 100 mL graduated cylinder, and left to stand, and the timing mechanism starts. The period when the solid material of the slurry is completely sedimented on the bottom of the graduated cylinder and the upper layer becomes a clear and transparent liquid is recorded as the settling time.

In the present disclosure, the crystallinity is calculated from the data of the X-ray powder diffraction pattern (XRD) spectrum.

In the present disclosure, the molar ratio of the carboxyl groups relative to a total amount of hydroxyl groups and carboxyl groups is measured as follows: dried sample powders are added into an NMR tube for a solid state C-NMR spectroscopy test, and the molar ratio is calculated from the data of the C-NMR spectrum as measured.

In the present disclosure, the diameter of the celluloses is determined by observing with a Scanning Electron Microscope, and can be seen in the Example 1 below for details.

It is expected that the surface-nanocrystallized cellulose-containing biomass material provided in the present disclosure has potential industrial application prospects in fire prevention, heat insulation, heat preservation, energy saving, anti-corrosion, anti-noise, anti-ultraviolet, anti-bacterial, wear-resisting, corrosion-resisting and the like. The surface-nanocrystallized cellulose-containing biomass material of the present disclosure has a wide range of application prospects, including but not limited to: a) processing raw materials for wood-based panel and wood plastic; b) substrates and composite functional nanomaterials for preparing functionalized and intellectuallized plates; c) water-based paints, including water-based interior wall paints, water-based protective coating layer and the like; d) substrates and composite functional nanopaints for preparing multifunctional or smart paints, including conductive paints, anti-bacteria and anti-corrosion paints, photocatalyst paints, sensing paints, heat insulation and fire prevention paints, and the like; e) materials for preparing biomass sponges; f) substrates and composite functional nanopaints for preparing multifunctional biomass sponges, including heat insulation and fire prevention sponges, sound insulation sponges, conductive sponges and the like; and g) materials for preparing high performance carbon materials by carbolysis at high temperature.

As a particular example, the inventors have found that the water-based paints (i.e., uniformly dispersed aqueous slurry) formed by directly dispersing the surface-nanocrystallized cellulose-containing biomass material of the present disclosure uniformly in water have good applications in indoor decorative materials due to the environmental protection characteristic of not containing any organic solvent and the special surface structures present on the surface of the surface-nanocrystallized cellulose-containing biomass material. Reference can be made to the Application Example provided herein for details.

In sum, with respect to the challenges in existing processing technologies for cellulose-containing biomass, the present disclosure provides a surface-nanocrystallized cellulose-containing biomass material and a preparation method thereof. A biomass material with high specific surface area, high surface activity and high crystallinity is obtained by subjecting a cellulose-containing biomass material (for example, particles) to a surface etching treatment, then oxidizing the exposed celluloses on the surface and carrying out a mechanical treatment. This provides an excellent raw material for further processing of a biomass material.

In order to further understand the present disclosure, the method for surface-nanocrystallizing a cellulose-containing biomass material of the present disclosure will be described in detail below with reference to the Examples, and the protection scopes of the present disclosure are not limited to the following Examples.

### EXAMPLES

### Example 1

A) 500 g of pine wood chips with a particle diameter of 200 mesh were soaked in 5 L of 10% sodium hydroxide solution at 80° C. for 24 h.

B) The alkaline solution on the surface of the treated wood chips was washed away. The wood chips were soaked in an oxidizing solution containing 0.1 mg/mL of 2,2,6,6-tetramethylpiperidine-N-oxide (with a chemical formula of C₉H₁₈NO, and a name of 2,2,6,6-tetramethylpiperidine-1-oxyl) and 1% of sodium chlorite with a pH=6.8 at 60° C. and oxidized for 24 h.

C) The biomass particles obtained after the surface oxidation were mechanically stirred, particularly with an IKA RW20 stirrer (Germany), at a rotation speed of 500 rpm for 2 hours.

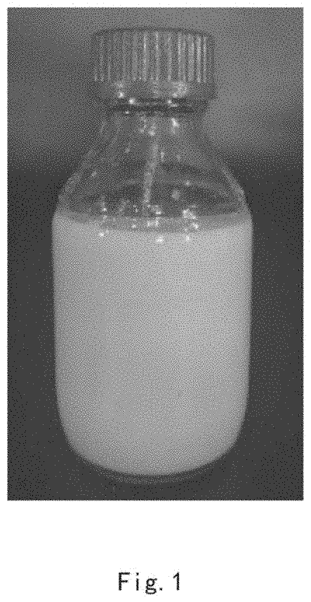

D) The biomass particles obtained after the mechanical treatment were dispersed in water to obtain an aqueous solution for storage. As shown in FIG. 1, the product obtained was a uniformly dispersed slurry without settling, while the wood chips which had not been surface nanocrystallized directly settled.

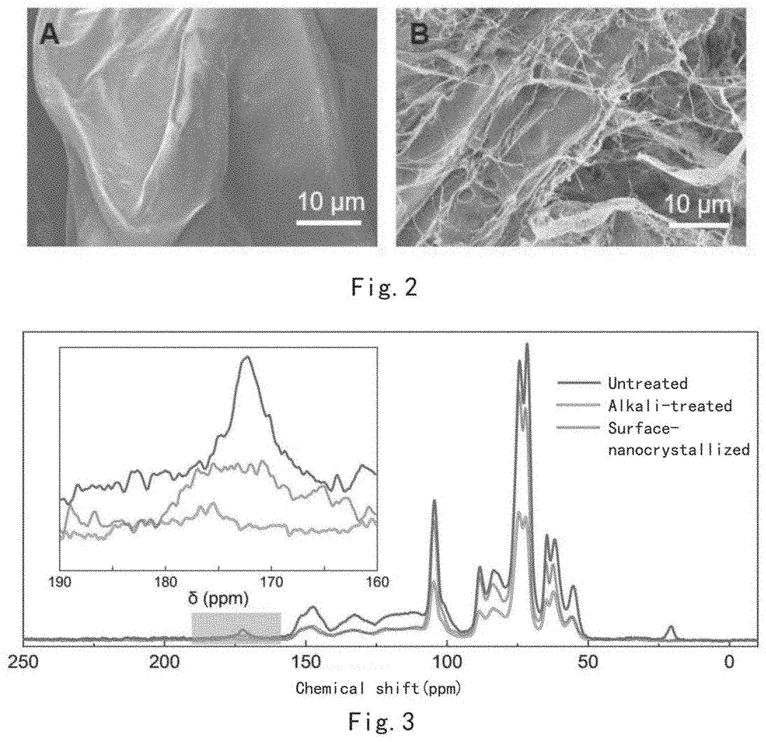

A large amount of nanocelluloses were produced on the surface of the product obtained after the surface-nanocrystallization, as shown in FIG. 2. The wood chips which had not been treated by the method of the present disclosure had a smooth surface, but had no nanocellulose structures (FIG. 2A); while a large amount of nanofiber structures were produced on the surface of the wood chips which had been treated by the method of the present disclosure, with a fiber diameter between 10 and 100 nm and a length between 0.5 and 5 μm (FIG. 2B).

After the surface-nanocrystallization, a portion of hydroxyl groups on the celluloses was converted to carboxyl groups, as shown in FIG. 3. The C-NMR spectrum of FIG. 3 shows that carboxyl peak appeared after the above treatment. It was calculated that 3.4% of hydroxyl groups had been converted to carboxyl groups during the treatment. The specific calculation was as follows: the content of the carboxyl groups equals to one third of the ratio of the integrated area for the peak at 175 ppm to the integrated area for the two peaks between 60 and 70 ppm in the C-NMR spectrum. In this Example, in the C-NMR spectrum of the sample, the area for the peak occurred at 174 ppm was 7424, and the integrated area of the two peaks between 60 and 70 ppm was 72244. Thus, it was calculated that the molar ratio of carboxyl groups was 3.4%.

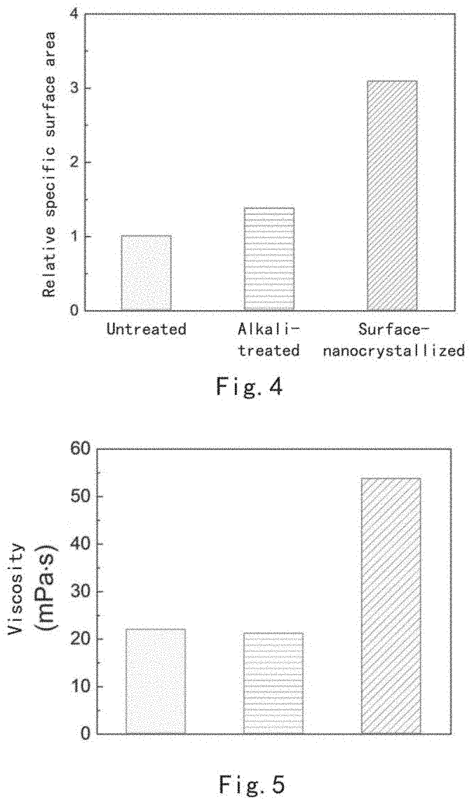

The product obtained after the surface nanocrystallization had an increased specific surface area, as shown in FIG. 4. In this Example, the specific surface area of the surface-crystallized wood chip particles was increased by a factor of 2.7.

The product obtained after the surface nanocrystallization had an increased viscosity, as shown in FIG. 5. In this Example, the viscosity of the surface-crystallized wood chip particles dispersed in an aqueous solution with a mass fraction of 6% was increased by a factor of 2.5, where the viscosity was measured at about 25° C. by a rotational viscometer method. The aqueous solution of the surface-nanocrystallized cellulose-containing biomass material was maintained in a uniformly dispersed state for long time. After left for one month, no caking precipitation or flocculation occurred. Thus, the settling time was longer than one month.

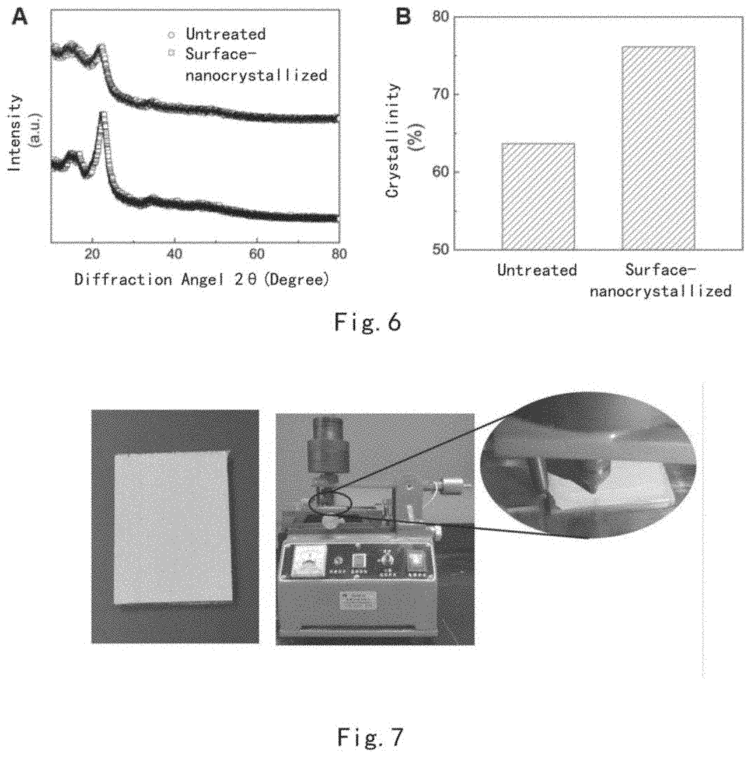

The product obtained after the surface-nanocrystallization had an increased crystallinity, as shown in FIG. 6. The crystallinity was calculated by subtracting the contrast at 20=18 from the contrast at 20=22.7 in the XRD spectrum to obtain a difference value and dividing the difference value by the contrast at 20=22.7.

### Example 2

A) 500 g of rape straw powders were soaked in 5 L of 10% sodium hydroxide solution at 80° C. for 24 h.

B) The alkaline solution on the surface of the treated powders was washed away. The powders were soaked in an oxidizing solution containing 0.1 mg/mL of 2,2,6,6-tetramethylpiperidine-N-oxide and 1% of sodium chlorite with a pH=6.8 at 60° C. and oxidized for 24 h.

C) The biomass particles obtained in B) after the surface oxidation were subjected to a mechanical ball milling treatment. The conditions for the ball milling were as follows. An aqueous solution having a mass content of 15% of the powders was charged into a 250 mL ball milling tank, and placed into a planetary ball mill, with a speed set value of 27 and a ball milling time of 8 hours.

D) The biomass particles obtained after the mechanical treatment were freeze dried into dry powders for storage.

### Example 3

A) 500 g of pine sawdusts were soaked in 5 L of 10% sodium hydroxide solution at 80° C. for 24 h.

B) The alkaline solution on the surface of the treated wood chips was washed away. The wood chips were soaked in an oxidizing solution containing 0.1 mg/mL of 2,2,6,6-tetramethylpiperidine-N-oxide and 1% of sodium chlorite with a pH=6.8 at 60° C. and oxidized for 24 h.

C) The biomass particles obtained in B) after the surface oxidation were mechanically stirred, particularly with an IKA RW20 stirrer (Germany), at a rotation speed of 400 rpm for 3 hours.

D) The biomass particles obtained in C) after the mechanical treatment were dispersed into an aqueous solution for storage.

### Example 4

A) Birch sawdusts were pulverized into powders with a pulverizer and screened with a 100 mesh sieve. Then, 500 g of powders were soaked in 5 L of 10% sodium hydroxide solution at 80° C. for 24 h.

B) The alkaline solution on the surface of the treated powders was washed away. The powders were soaked in an oxidizing solution containing 0.1 mg/mL of 2,2,6,6-tetramethylpiperidine-N-oxide and 1% of sodium chlorite with a pH=6.8 at 60° C. and oxidized for 24 h.

C) The biomass particles obtained in B) after the surface oxidation were subjected to a mechanical ball milling treatment. The conditions for the ball milling were as follows. An aqueous solution of the powders with a mass content of 15% was charged into a 250 mL ball milling tank, and placed into a planetary ball mill, with a speed set value of 27 and a ball milling time of 8 hours.

D) The biomass particles obtained in C) after the mechanical treatment were freeze dried into dry powders for storage.

The dry powders obtained after the surface crystallization could be uniformly dispersed in an aqueous phase without settling, while the birch wood chips which had not been surface-nanocrystallized directly settled. Meanwhile, a large amount of nanocellulose structures were produced on the surface of the nanocrystallized product, with a fiber diameter between 10 and 100 nm and a fiber length between 0.5 and 5 μm. The birch wood chips which had not been treated by the method of the present disclosure had a smooth surface, but had no nanocellulose structures.

After the surface nanocrystallization, a portion of hydroxyl groups on the celluloses was converted to carboxyl groups. It can be known from the calculation of the carboxyl peak occurred in the C-NMR spectrum that 2.9% of hydroxyl groups had been converted to carboxyl groups during the treatment.

The product obtained after the surface nanocrystallization had an increased specific surface area. In this Example, the specific surface area of the surface-crystallized birch wood chip particles was increased by a factor of 2.4, and was particularly 43.2 m²/g.

The product obtained after the surface nanocrystallization had an increased viscosity. In this Example, the viscosity of the surface-crystallized birch wood chip particles dispersed in an aqueous solution with a mass fraction of 6% was increased by a factor of 2.1, and was particularly measured to be 42 mPa·s at 25° C., where the viscosity was measured at about 25° C. by a rotational viscometer method.

The product obtained after the surface nanocrystallization had an increased crystallinity of 67%.

The aqueous solution of the surface-nanocrystallized cellulose-containing biomass material was maintained in a uniformly dispersed state for long time. After being left for one month, no caking precipitation or flocculation occurred. Thus, the settling time was longer than one month.

### Example 5

A) Rape straw was pulverized into powders with a pulverizer and screened with a 200 mesh sieve. Then, 500 g of powders were soaked in 5 L of 10% sodium hydroxide solution at 80° C. for 24 h.

B) The alkaline solution on the surface of the treated rape straw powders was washed away. The powders were soaked in an oxidizing solution containing 0.1 mg/mL of 2,2,6,6-tetramethylpiperidine-N-oxide and 1% of sodium chlorite with a pH=6.8 at 60° C. and oxidized for 24 h.

C) The biomass particles in B) obtained after the surface oxidation were mechanically stirred, particularly with an IKA RW20 stirrer (Germany), at a rotation speed of 400 rpm for 3 hours.

D) The biomass particles obtained in C) after the mechanical treatment were freeze dried into dry powders for storage.

The dry powders obtained after the surface crystallization could be uniformly dispersed in an aqueous phase without settling, while the rape straw powders which had not been surface nanocrystallized directly settled. Meanwhile, a large amount of nanocellulose structures was produced on the surface of the nanocrystallized product, with a fiber diameter between 10 and 100 nm and a fiber length between 0.5 and 5 μm. The rape straw powders which had not been treated by the method of the present disclosure had a smooth surface, but had no nanocellulose structures.

After the surface nanocrystallization, a portion of hydroxyl groups on the celluloses was converted to carboxyl groups. It can be known from the calculation of the carboxyl peak occurred in the C-NMR spectrum that 3.3% of hydroxyl groups had been converted to carboxyl groups during the treatment.

The product obtained after the surface nanocrystallization had an increased specific surface area. In this Example, the specific surface area of the surface-crystallized rape straw powders was increased by a factor of 2.5, and was particularly 42.5 m²/g.

The product obtained after the surface nanocrystallization had an increased viscosity. In this Example, the viscosity of the surface-crystallized rape straw powders in an aqueous solution with a mass fraction of 6% was increased by a factor of 2.5, and was particularly measured to be 52.5 mPa·s at 25° C., where the viscosity was measured at about 25° C. by a rotational viscometer method.

The product obtained after the surface nanocrystallization had an increased crystallinity of 73.6%.

The aqueous solution of the surface-nanocrystallized cellulose-containing biomass material was maintained in a uniformly dispersed state for long time. After being left for one month, no caking precipitation or flocculation occurred. Thus, the settling time was longer than one month.

### Example 6

The process for preparing surface-nanocrystallized rice straw particles of 150 mesh is provided herein.

A) Rice straw was pulverized into powders with a pulverizer and screened with a 150 mesh sieve. Then, 500 g of powders were soaked in 5 L of 10% sodium hydroxide solution at 80° C. for 24 h.

B) The alkaline solution on the surface of the treated rice straw powders was washed away. The powders were soaked in an oxidizing solution containing 0.1 mg/mL of 2,2,6,6-tetramethylpiperidine-N-oxide and 1% of sodium chlorite with a pH=6.8 at 60° C. and oxidized for 24 h.

C) The biomass particles obtained in B) after the surface oxidation were subjected to a mechanical ball milling treatment. The conditions for the ball milling were as follows. An aqueous solution of the powders with a mass content of 15% was charged into a 250 mL ball milling tank, and placed into a planetary ball mill, with a speed set value of 27 and a ball milling time of 8 hours.

D) The biomass particles obtained after the mechanical treatment were freeze dried into dry powders for storage.

The product obtained after the surface crystallization could be uniformly dispersed in an aqueous phase without settling, while the rice straw powders which had not been surface nanocrystallized directly settled. Meanwhile, a large amount of nanocellulose structures were produced on the surface of the nanocrystallized product, with a fiber diameter between 10 and 100 nm and a fiber length between 0.5 and 5 μm. The rice straw powders which had not been treated by the method of the present disclosure had a smooth surface, but had no nanocellulose structures.

After the surface nanocrystallization, a portion of hydroxyl groups on the celluloses was converted to carboxyl groups. It can be known from the calculation of the carboxyl peak occurred in the C-NMR spectrum that 3.2% of hydroxyl groups had been converted to carboxyl groups during the treatment.

The product obtained after the surface nanocrystallization had an increased specific surface area. In this Example, the specific surface area of the surface-crystallized rice straw powders was increased by a factor of 2.3, and was particularly 48.3 m²/g.

The product obtained after the surface nanocrystallization had an increased viscosity. In this Example, the viscosity of the surface-crystallized rice straw powders dispersed in an aqueous solution with a mass fraction of 6% was increased by a factor of 2.2, and was particularly measured to be 41.8 mPa·s at 25° C., where the viscosity was measured at about 25° C. by a rotational viscometer method.

The aqueous solution of the surface-nanocrystallized cellulose-containing biomass material was maintained in a uniformly dispersed state for long time. After being left for one month, no caking precipitation or flocculation occurred. Thus, the settling time was longer than one month.

### Example 7

The process for preparing surface-nanocrystallized particles of oriental plane leaf with a size of 200 mesh is provided herein.

A) Oriental plane leaves were pulverized into powders with a pulverizer and screened with a 200 mesh sieve. Then, 500 g of powders were soaked in 5 L of 10% sodium hydroxide solution at 80° C. for 24 h.

B) The alkaline solution on the surface of the treated oriental plane leaf powders was washed away. The powders were soaked in an oxidizing solution containing 0.1 mg/mL of 2,2,6,6-tetramethylpiperidine-N-oxide and 1% of sodium chlorite with a pH=6.8 at 60° C. and oxidized for 24 h.

C) The biomass particles obtained in B) after the surface oxidation were mechanically stirred, particularly with an IKA RW20 stirrer (Germany), at a rotation speed of 400 rpm for 3 hours.

D) The biomass particles obtained in C) after the mechanical treatment were freeze dried into dry powders for storage.

The product obtained after the surface crystallization could be uniformly dispersed in an aqueous phase without settling, while the oriental plane leaf powders which had not been surface nanocrystallized directly settled. Meanwhile, a large amount of nanocellulose structures were produced on the surface of the nanocrystallized product, with a fiber diameter between 10 and 100 nm and a fiber length between 0.5 and 5 μm. The oriental plane leaf powders which had not been treated by the method of the present disclosure had a smooth surface, but had no nanocellulose structures.

After the surface nanocrystallization, a portion of hydroxyl groups on the celluloses was converted to carboxyl groups. It can be known from the calculation of the carboxyl peak occurred in the C-NMR spectrum that 3.3% of hydroxyl groups had been converted to carboxyl groups during the treatment.

The product obtained after the surface nanocrystallization had an increased specific surface area. In this Example, the specific surface area of the surface-crystallized oriental plane leaf powders was increased by a factor of 2.6, and was particularly 41.6 m²/g.

The product obtained after the surface nanocrystallization had an increased viscosity. In this Example, the viscosity of the surface-crystallized oriental plane leaf powders dispersed in an aqueous solution with a mass fraction of 6% was increased by a factor of 2.4, and was particularly measured to be 55.2 mPa·s at 25° C., where the viscosity was measured at about 25° C. by a rotational viscometer method.

The product obtained after the surface nanocrystallization had an increased crystallinity of 68%.

The aqueous solution of the surface-nanocrystallized cellulose-containing biomass material was maintained in a uniformly dispersed state for long time. After being left for one month, no caking precipitation or flocculation occurred. Thus, the settling time was longer than one month.

### Example 8

The process for preparing surface-nanocrystallized particles of maple leaf with a size of 200 mesh is provided herein.

A) Maple leaves were pulverized into powders with a pulverizer and screened with a 200 mesh sieve. Then, 500 g of powders were soaked in 5 L of 10% sodium hydroxide solution at 80° C. for 24 h.

B) The alkaline solution on the surface of the treated maple leaf powders was washed away. The powders were soaked in an oxidizing solution containing 0.1 mg/mL of 2,2,6,6-tetramethylpiperidine-N-oxide and 1% of sodium chlorite with a pH=6.8 at 60° C. and oxidized for 24 h.

C) The biomass particles obtained in B) after the surface oxidation were subjected to a mechanical ball milling treatment. The conditions for the ball milling were as follows. An aqueous solution of the powders with a mass content of 15% was charged into a 250 mL ball milling tank, and placed into a planetary ball mill, with a speed set value of 27 and a ball milling time of 8 hours.

D) The biomass particles obtained in C) after the mechanical treatment were freeze dried into dry powders for storage.

The product obtained after the surface crystallization could be uniformly dispersed in an aqueous phase without settling, while the maple leaf powders which had not been surface nanocrystallized directly settled. Meanwhile, a large amount of nanocellulose structures were produced on the surface of the nanocrystallized product, with a fiber diameter between 10 and 100 nm and a fiber length between 0.5 and 5 μm. The maple leaf powders which had not been treated by the method of the present disclosure had a smooth surface, but had no nanocellulose structures.

After the surface nanocrystallization, a portion of hydroxyl groups on the celluloses was converted to carboxyl groups. It can be known from the calculation of the carboxyl peak occurred in the C-NMR spectrum that 3.5% of hydroxyl groups had been converted to carboxyl groups during the treatment.

The product obtained after the surface nanocrystallization had an increased specific surface area. In this Example, the specific surface area of the surface-crystallized maple leaf powders was increased by a factor of 2.8, and was particularly 44.8 m²/g.

The product obtained after the surface nanocrystallization had an increased viscosity. In this Example, the viscosity of the surface-crystallized powders of maple leaf dispersed in an aqueous solution with a mass fraction of 6% was increased by a factor of 2.7, and was particularly measured to be 56.7 mPa·s at 25° C., where the viscosity was measured at about 25° C. by a rotational viscometer method.

The product obtained after the surface nanocrystallization had an increased crystallinity of 71.2%.

The aqueous solution of the surface-nanocrystallized cellulose-containing biomass material was maintained in a uniformly dispersed state for long time. After being left for one month, no caking precipitation or flocculation occurred. Thus, the settling time was longer than one month.

### Application Example 1

A) The surface-nanocrystallized biomass particles obtained in Example 1 were dispersed in water to obtain a slurry with a mass concentration of 20%, which was a water-based paint.

B) The water-based paint was applied on the surface of a wood board and naturally dried to obtain a uniform coating layer.

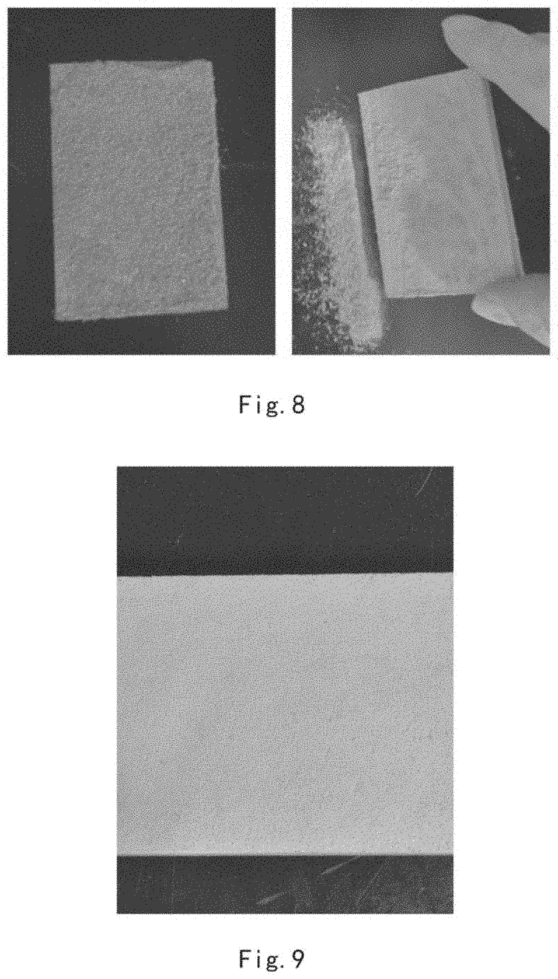

The photograph taken after the paint had been applied on the surface of the wood board is as shown in FIG. 7. As can be seen from FIG. 7, the coating layer obtained was uniform. Also, in a scratch test with a load of 1.45 kilograms, only minor scratches appeared, without penetration. In comparison, as shown in FIG. 8, a slurry of the same kind of wood chip sample which had not been treated by the method of the present disclosure was applied to the same substrate and dried. After that, no coating layer was formed, and the sample was still in a powder form. The powders fell off after tilting the substrate.

### Application Example 2

Use as a decorative material in a construction such as wall film.

The surface-nanocrystallized cellulose-containing biomass material prepared in Example 1 was directly dispersed in water to obtain a slurry with a solid content of 60 mass %, and an application test of the slurry was performed on a decorative material in a construction. The slurry was applied on a cement board substrate of 10 cm*10 cm, which was then vertically positioned in an upright position in an indoor environment with a humidity of 53% and a temperature of 25° C. to be naturally dried.

FIG. 9 shows a digital photograph of an aqueous slurry formed from the surface-nanocrystallized cellulose-containing biomass material prepared in Example 1 of the present disclosure after the aqueous slurry is applied to a substrate of cement board for one month. As can be seen, it still keep stable apparent properties, and it does not fall off, peel off or wrinkle due to normal changes in the temperature and humidity of the ambient environment.

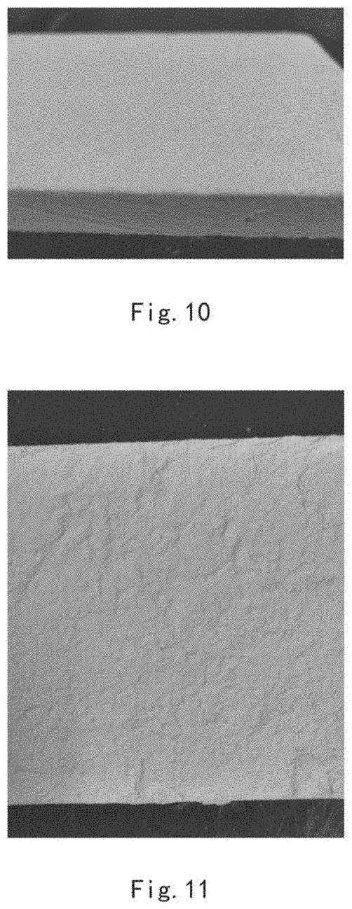

FIG. 10 shows a scratch test for an aqueous slurry formed from the surface-nanocrystallized cellulose-containing biomass material prepared in Example 1 of the present disclosure when the slurry is applied to a substrate of cement board. No scratch appears until the load reaches 1.50 kg, indicating a good scratch resistance.

### Application Comparative Example 1

A cellulose-containing biomass material which had not been surface nanocrystallized was directly dispersed in water to obtain a slurry with a solid content of 60 mass %, which was referred to as a Comparative Slurry.

An application test of the Comparative Slurry was performed on a decorative material in a construction. The Comparative Slurry was applied on a cement board substrate of 10 cm*10 cm. The paint would slide down when the cement board was vertically positioned in an upright position. Thus, the cement board was horizontally positioned in an indoor environment with a humidity of 53% and a temperature of 25° C. to be naturally dried.

FIG. 11 shows a digital photograph of a comparative slurry coating material after it is applied to a substrate of cement board for one month. As can be seen, its appearance is obviously granular; the material as a whole is relatively loose, and cannot form a tough coating film.

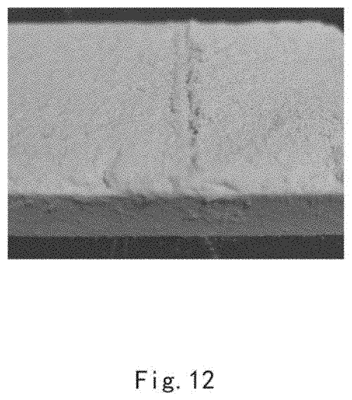

FIG. 12 shows a scratch test for the comparative slurry coating material applied to a substrate of cement board. Scratches appear at a load of 0 kg, indicating a poor scratch resistance.

The description of particular embodiments and examples above is only intended to assist in understanding the method and concept of the present disclosure. It should be noted that some modifications and variations can be made to the present disclosure by a person skilled in the art without departing from the principle and spirit of the present disclosure. These modifications and variations also fall within the protection scope of the claims of the present disclosure.

1. A surface-nanocrystallized cellulose-containing biomass material, wherein the cellulose-containing biomass material is derived from one or more of biomass materials containing cellulose components from natural plants or animals, wherein a surface of the surface-nanocrystallized cellulose-containing biomass material has an exposed region, and celluloses in the exposed region are nanoscale celluloses, and wherein a portion of hydroxyl groups in the nanoscale celluloses has been converted to carboxyl groups, such that the surface-nanocrystallized cellulose-containing biomass material has at least one of following properties:
i) that the surface-nanocrystallized cellulose-containing biomass material has a specific surface area of at least 1.5 m²/g;
ii) that surface-exposed celluloses in the surface-nanocrystallized cellulose-containing biomass material after nanocrystallization have a diameter of at least 1 μm or less;
iii) that in the surface-nanocrystallized cellulose-containing biomass material, the celluloses have a crystallinity of at least 65%;
iv) that in the surface-nanocrystallized cellulose-containing biomass material, a molar ratio of carboxyl groups relative to a total amount of hydroxyl groups and carboxyl groups is at least 5%;
v) that the surface-nanocrystallized cellulose-containing biomass material has a viscosity of at least 40 mPa·s in an aqueous solution with a mass fraction of 6%, as measured at about 25° C. by a rotational viscometer method; and
vi) that an aqueous solution of the surface-nanocrystallized cellulose-containing biomass material has a settling time of at least 200 minutes or longer.

2. The surface-nanocrystallized cellulose-containing biomass material according to claim 1, wherein the surface-exposed celluloses after surface nanocrystallization have a fiber length in a range from 0.1 to 5 μm.

3. The surface-nanocrystallized cellulose-containing biomass material according to claim 1, wherein the cellulose-containing biomass material has a cellulose content of 10% to 90%.

4. The surface-nanocrystallized cellulose-containing biomass material according to claim 1, wherein the natural plants or animals are at least one selected from the group consisting of wood, saw dust, leaf, straw, hay, hemp, bamboo, bagasse or rice hull of natural plants, and seashell of natural animals.

5. A method for preparing a surface-nanocrystallized cellulose-containing biomass material, comprising steps of:
A) subjecting a cellulose-containing biomass material to a surface etching treatment in an etching solution, wherein the cellulose-containing biomass material is one or more selected from biomass materials containing cellulose components from natural plants or animals;
B) subjecting the cellulose-containing biomass material after the etching treatment to a surface oxidation treatment;
C) subjecting the cellulose-containing biomass material after the surface oxidation to a mechanical treatment; and
D) making the cellulose-containing biomass material after the mechanical treatment form a dispersion solution or dry powder for storage.

6. The method according to claim 5, wherein the etching solution comprises at least one selected from the group consisting of aqueous sodium hydroxide solution, aqueous potassium hydroxide solution, aqueous sodium sulfite solution, aqueous sulfur dioxide solution, aqueous sulphurous acid solution, and a solvent capable of dissolving biomacromolecules.

7. The method according to claim 5, wherein the surface oxidation treatment comprises oxidizing surface-exposed celluloses of the cellulose-containing biomass material under a catalytic action of 2,2,6,6-tetramethylpiperidine-N-oxide.

8. The method according to claim 5, wherein in step A), the etching is performed at a temperature of 10-200° C. for 1-72 h.

9. The method according to claim 5, wherein in step B), the oxidation treatment is performed at a temperature of 10-150° C. for 6-240 h.

10. The method according to claim 5, wherein in step B), the surface oxidation treatment is performed by oxidizing surface of celluloses in the cellulose-containing biomass material with an oxidizing agent under a catalytic action of 2,2,6,6-tetramethylpiperidine-N-oxide, and wherein the oxidizing agent comprises at least one water-soluble oxidizing agent selected from the group consisting of sodium chlorite, sodium hypochlorite, sodium bromite, and sodium hypobromite.

11. The method according to claim 5, wherein the mechanical treatment comprises one or more selected from the group consisting of stirring, grinding, high pressure homogenization and high pressure injection.

12. (canceled)

13. (canceled)

14. (canceled)
